(19) United States
(12) Patent Application Publication
(10) Pub. No.: US 2017/0032300 A1
(43) Pub. Date: Feb. 2, 2017

(54) DYNAMIC SELECTION OF RESOURCES ON WHICH AN ACTION IS PERFORMED

(71) Applicant: International Business Machines Corporation, Armonk, NY (US)

(72) Inventors: Bertus Eggen, Koln (DE); John F. Hollingsworth, Wynnewood, PA (US); Baiju D. Mandalia, Boca Raton, FL (US)

(21) Appl. No.: 14/814,577

(22) Filed: Jul. 31, 2015

(51) Int. Cl. G06Q 10/06

(52) U.S. Cl. CPC G06Q 10/06313

(57) ABSTRACT

A method, and an associated system, of dynamic resource selection for performing an action A on the selected resources. At each time tⱼ equal to jT₁ for j=1, 2, . . . , J such that J is a positive integer of at least T_{M}/T₁: (i) a current time tⱼ=jT₁ is computed, wherein T₁ is a first heartbeat of heartbeats T₁, T₂, . . . T_{M}; (ii) T_{K} is determined as a largest heartbeat T satisfying tⱼ mod T=0; (iii) a probability vector P corresponding to T_{K} is determined; (iv) resources whose associated probability in vector P exceeds a predetermined threshold is ascertained; (v) actions are performed on the ascertained resources; and (vi) j is incremented by 1 if j<J.

### TECHNICAL FIELD

The present invention is directed to a dynamic state machine to implement dynamic selection of resources on which an action is performed.

### BACKGROUND

A finite state machine is a system or model that includes a finite number of states and controls a transition from one state to another in response to a triggering condition or event. A dynamic state machine is a finite state machine in which state transitions occur in response to real-time triggering conditions or events.

### BRIEF SUMMARY

The present invention provides a method, and associated system and computer program product, of dynamic resource selection for performing an action A on the selected resources. The resource selection is in consideration [R], [T], [P] and P_{L}. [R] denotes an ordered sequence of N resources denoted as R₁, R₂, . . . , R_{N} such that N is an integer of at least 3. [T] denotes an ordered sequence of M heartbeats denoted as T₁, T₂, . . . , T_{M}, such that 0<T₁<T₂< . . . <T_{M}, wherein each heartbeat Tₘ (m=1, 2, . . . , M) is an integral multiple of T₁ and M is an integer of at least 2. [P] denotes, for each heartbeat Tₘ (m=1, 2, . . . , M), a probability of occurrence Pₙₘ of the action A on resource Rₙ within a period of time equal to the heartbeat Tₘ, wherein P₁ₘ, P₂ₘ, . . . , P_{Nm} is an ordered sequence of N probabilities corresponding to Tₘ and respectively corresponding to the ordered sequence of N resources R₁, R₂, . . . , R_{N}. P_{L} denotes a specified lower-limit threshold probability value. At each time tⱼ equal to jT₁ for j=1, 2, . . . , J such that J is a positive integer of at least T_{M}/T₁:

(i) a hardware processor determines K as being a largest integer k from 1 to M satisfying tⱼ mod Tₖ=0, which determines a current heartbeat T=T_{K};

(ii) the processor determines a probability vector P corresponding to heartbeat T_{K}, wherein P is denoted as P_{1K}, P_{2K}, . . . , and P_{NK}; and

(iii) the processor determines a set {R} of resources from [R], wherein each resource R in the set {R} corresponds to a respective probability P in a set {P} selected from P_{1K}, P_{2K}, . . . , and P_{NK} such that each probability P in the set {P} satisfies P>P_{L}, wherein the action A is configured to be performed on each resource R in the set {R}.

### BRIEF DESCRIPTION OF THE DRAWINGS

FIG. 1 depicts a dynamic state machine architecture, in accordance with embodiments of the present invention.

FIG. 2 is a flow chart of a method of dynamic resource selection for performing an action A on the selected resources, in accordance with embodiments of the present invention.

FIGS. 3 and 4 each depict a different process for implementing a determination of resources on which the action A is to be performed in the method of FIG. 2, in accordance with embodiments of the present invention.

FIG. 5 depicts an application-specific integrated circuit (ASIC), in accordance with embodiments of the present invention.

FIG. 6 illustrates a computer system used for dynamic resource selection for performing an action on the selected resources, in accordance with embodiments of the present invention.

### DETAILED DESCRIPTION

The present invention provides a method, and associated system and computer program product, of dynamic state selection for performing an action on the selected states. The dynamic state selection utilizes probabilities of the occurrence of the action for each state in a dynamic state machine implementation.

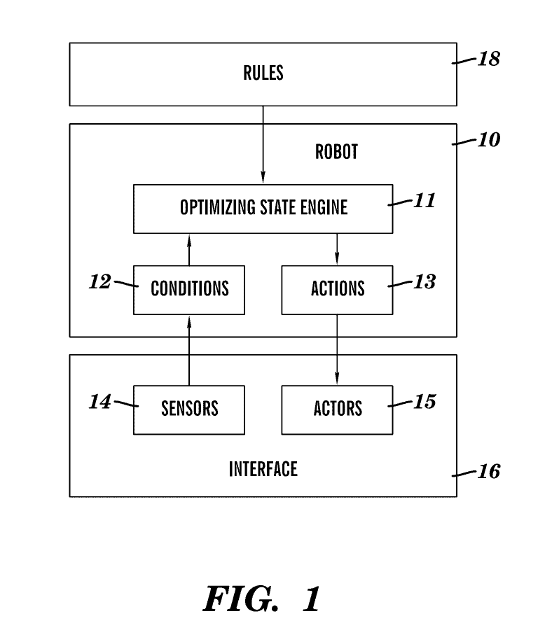

FIG. 1 depicts a dynamic state machine architecture, in accordance with embodiments of the present invention. In one embodiment, the dynamic state machine is implemented as an appliance which may be a robot 10 with sensors 14. The appliance can be a USB stick with a processor or a virtual machine deployed in a hypervisor. The robot comprises an optimizing state engine 11, conditions 12, actions 13, the sensors 14, and actors 15.

The description of present invention will presented in a generalized, form but first is illustrated with an example of Database Repository Mirroring (DRM) (hereinafter, “DRM example”). In one embodiment, the DRM example is implemented for customers across multiple data centers. In the prior art, DRM can be expensive in terms of processing and network resources. The present invention uses an efficient or optimized dynamic state machine to minimize resource usage.

In the DRM example, each repository of one or more repositories in a database contains one or more types of data content (hereinafter, “content types”). Examples of different content types include, inter alia, employee salary data, inventory data, employee performance appraisal data, customer data, physical plant data, security data, physical resources data, software verification data, etc.

Each content type in each repository may be updated at each time of a sequence of times with a constant time interval between successive times in the sequence. At each time in the sequence, each content type in each repository is determined, in accordance with methodology of the present invention, to be either in an “update” state (i.e., to be updated) or in a “no-update” state (i.e., not to be updated). In one embodiment, a binary variable can be used to represent the state of the content type in each repository at any given time in the sequence of times; e.g., “1” represents the update state and “0” represents the no-update state.

Replication logic may control asynchronous mirroring of the content types in each repository in the database to other storage such as an auxiliary database. The database changes patterns in the content types of each repository and a history/learning engine creates triggers/sensors in accordance with a probability of each content type in each repository being updated in a given time interval, the probability being based on average changes over time historically.

In the DRM example, the components of the robot 10 in FIG. 1 are as follows. The actions 13 include the action of updating content types in each repository. The actors 15 issue replication commands by repository. The conditions 12 are time intervals (called “heartbeats”; e.g., 10 seconds, 1 minute, 5 minutes, 30 minutes 1 hour) for updating content types in each repository. The sensors 14 are probabilities of occurrence of the updating action on each content type in each repository for the time intervals of the conditions 12. The user may interact with the robot 10 via one or more interfaces 16 which may include a keyboard, mouse, graphical user interface (GUI) on a display screen of a computer, monitor, portable device (e.g., tablet, smart phone, etc.).

The optimizing state engine 11 is software or hardware, which upon being executed or activated, respectively, performs the inventive method of dynamic state determination for performing an action (e.g., the updating action in the DRM example) on the content types in each repository. In one embodiment, the optimizing state engine 11 performs the inventive method in accordance with rules 18.

The robot 10 has a state for update for content type in each repository and issues commands to the replication logic for asynchronous mirroring. The robot 10 receives inputs from sensors 14 (probability on the changes by repository) and decides on a next state for each content type in each repository, based on the sensor probability patterns which are a function of the heartbeat that exists at the current time. In one embodiment, the robot 10 is implemented as a virtualized server in a data center.

The probabilities of occurrence of the updating action on each content type in each repository are inputs to the inventive method of computing the next state. In one embodiment, the probabilities may be determined as being proportional to an average number of changes, in each heartbeat time interval, that have occurred historically for each content type in each repository.

Table 1 lists M heartbeats (M=5) in the DRM example.

TABLE 1

| m | Heartbeat, Tₘ |
|---|---|
| 1 | 10 seconds |
| 2 | 1 minute (60 seconds) |
| 3 | 5 minutes (300 seconds) |
| 4 | 30 minutes (1800 seconds) |
| 5 | 1 hour (3660 seconds) |

State transitions, namely updates of content type in each repository, may occur at multiples of T₁; i.e. every 10 seconds, every 20 seconds, every 30 seconds, etc. Thus, state transitions may occur at each time tⱼ equal to jT₁ (j=1, 2, . . . , J), wherein J is a positive integer of at least T_{M}/T₁, which assures that each heartbeat of the M heartbeats is used to determine state transitions at various times tⱼ.

Table 2 presents exemplary probabilities (Pₙₘ) for the DRM example.

TABLE 2

| | | Probability, Pₙₘ | | | | |
|---|---|---|---|---|---|---|
| | | T₁ = | T₂ = | T₃ = | T₄ = | T₅ = |
| Content, | Reposi- | 10 sec | 60 sec | 300 sec | 1800 sec | 3600 sec |
| n | tory | (m = 1) | (m = 2) | (m = 3) | (m = 4) | (m = 5) |
| 1 | 1 | 0.8 | 0.9 | 1 | 1 | 1 |
| 2 | 1 | 0 | 0.1 | 0.5 | 0.8 | 1 |
| 3 | 1 | 0.9 | 1 | 1 | 1 | 1 |
| 4 | 1 | 0 | 0 | 0.5 | 0.8 | 0.9 |
| 5 | 1 | 0 | 0 | 0.7 | 0.9 | 1 |
| 6 | 2 | 1 | 1 | 1 | 1 | 1 |
| 7 | 2 | 0.7 | 0.9 | 1 | 1 | 1 |
| 8 | 2 | 0 | 0.7 | 1 | 1 | 1 |
| 9 | 2 | 0 | 0.5 | 1 | 1 | 1 |
| 10 | 3 | 0 | 0.8 | 1 | 1 | 1 |
| 11 | 3 | 1 | 1 | 1 | 1 | 1 |
| 12 | 3 | 1 | 1 | 1 | 1 | 1 |
| 13 | 3 | 0.4 | 0.6 | 1 | 1 | 1 |
| 14 | 3 | 1 | 1 | 1 | 1 | 1 |
| 15 | 3 | 0.2 | 0.4 | 0.8 | 1 | 1 |

In Table, 2, the total number (N) of content in the three repositories (1, 2, 3) is 15, distributed as: content 1-5 in repository 1, content 6-9 in repository 2, and content 10-15 in repository 3, which illustrates that each repository comprises a number of content that is specific to each repository.

In one embodiment, the three repositories may be sufficiently similar to each other, or clones of each other, so that content 1-5, 6-10, and 11-15 will exist in repository 1, 2, and 3, respectively, such that: content 1, 6, and 11 are of a same content type, content 2, 7, and 12 are of a same content type, content 3, 8, and 13 are of a same content type, content 4, 9, and 14 are of a same content type, and content 5, 10, and 15 are of a same content type.

The following pseudo code for program MIRROR1, between BEGIN and END, determines which content to mirror (i.e., which content to update) at each time (tⱼ) tested.

/* Program MIRROR1 */
BEGIN

| | |
|---|---|
| /* | tⱼ=current time j, J=max j, T=heartbeat, T₁=10, P_{L}=threshold |
| | probability (e.g., 0.5) */ |
| | j = 1; |

Time /* increment update time */

tⱼ = jT₁

Heartbeat
/* P = (P₁, P₂. ..., P_{N}), N =15 */

if tⱼ mod (3600) = 0, then heartbeat (T) = T₅; P = Pₙ₅ (column T₅);
go to State;
if tⱼ mod (1800) = 0, then heartbeat (T) = T₄; P = Pₙ₄ (column T₄);
go to State;
if tⱼ mod (300) = 0, then heartbeat (T) = T₃; P = Pₙ₃ (column T₃);
go to State;
if tⱼ mod (60) = 0, then heartbeat (T) = T₂; P = Pₙ₂ (column T₂);
go to State;
if tⱼ mod (10) = 0, then heartbeat (T) = T₁; P = Pₙ₁ (column T₁);
go to State;

State

for (n = 1 to n = 15) if Pₙ > P_{L} then Sₙₘ =1 and mirror content n,
else Sₙₘ =0;
If j < J then j = j+ 1; go to Time else exit

END

In the MIRROR1 program, the times tested are in 10 second increments, as denoted by times tⱼ=jT₁ (T₁=10 seconds). At each time tested (tⱼ), a current heartbeat T is determined as being the largest heartbeat T=Tₘ satisfying tⱼ mod Tₘ=0, wherein “mod” denotes modulus at base 10. The heartbeat index m selects the m^{th} heartbeat from heartbeats T₁, T₂, T₃, T₄, and T₅ (see Table 2). P is a vector of 15 probabilities indexed by n, namely the column of Pₙₘ in Table 2 whose heartbeat Tₘ satisfies tⱼ mod Tₘ=0. Thus Pₙ denotes element n within the vector P and is associated with content n. At each update time, content n (n=1, 2, . . . , N; N=15) has a state 1 (updated) or 0 (not updated). Thus the composite content of the N contents has a state vector S (S₁, S₂, . . . , S_{N}) whose elements Sₙ (n=1, 2, . . . , 15) have a state value of 1 if content n is updated and a state value of 0 if content n is not updated.

Noting that Pₙₘ is a function of T (the current heatbeat), the state vector S is also a function of T as determined by the state being 1 if Pₙₘ>P_{L} and the state being 0 otherwise. Thus, the state vectors (S) can be combined to form a two-dimensional state matrix S having elements Sₙₘ, illustrated in Table 3 which is derived from the Pₙₘ values in Table 2 together with the state being 1 if Pₙₘ>P_{L} and the state being 0 otherwise.

TABLE 3

| | | State Matrix, Sₙₘ | | | | |
|---|---|---|---|---|---|---|
| | | T₁ = | T₂ = | T₃ = | T₄ = | T₅ = |
| | Reposi- | 10 sec | 60 sec | 300 sec | 1800 sec | 3600 sec |
| Content, n | tory | (m = 1) | (m = 2) | (m = 3) | (m = 4) | (m = 5) |
| 1 | 1 | 1 | 1 | 1 | 1 | 1 |
| 2 | 1 | 0 | 0 | 0 | 1 | 1 |
| 3 | 1 | 1 | 1 | 1 | 1 | 1 |
| 4 | 1 | 0 | 0 | 0 | 1 | 1 |
| 5 | 1 | 0 | 0 | 1 | 1 | 1 |
| 6 | 2 | 1 | 1 | 1 | 1 | 1 |
| 7 | 2 | 1 | 1 | 1 | 1 | 1 |
| 8 | 2 | 0 | 1 | 1 | 1 | 1 |
| 9 | 2 | 0 | 0 | 1 | 1 | 1 |
| 10 | 3 | 0 | 1 | 1 | 1 | 1 |
| 11 | 3 | 1 | 1 | 1 | 1 | 1 |
| 12 | 3 | 1 | 1 | 1 | 1 | 1 |
| 13 | 3 | 0 | 1 | 1 | 1 | 1 |
| 14 | 3 | 1 | 1 | 1 | 1 | 1 |
| 15 | 3 | 0 | 0 | 1 | 1 | 1 |

The following alternative program MIRROR2 includes a Sort step for sorting the probability vector P before determining the state of each content.

/* Program MIRROR2 */
BEGIN

| | |
|---|---|
| /* | tⱼ=current time j, J=max j, T=heartbeat, T₁=10, P_{L}=threshold |
| | probability (e.g., 0.5) */ |
| | j = j; |

Time /* increment update time */

tⱼ = jT₁

Heartbeat
/* P = (P₁, P₂. ..., P_{N}), N =15 */

if tⱼ mod (3600) = 0, then heartbeat (T) = T₅; P = Pₙ₅ (column T₅);
go to Sort;
if tⱼ mod (1800) = 0, then heartbeat (T) = T₄; P = Pₙ₄ (column T₄);
go to Sort;
if tⱼ mod (300) = 0, then heartbeat (T) = T₃; P = Pₙ₃ (column T₃);
go to Sort;
if tⱼ mod (60) = 0, then heartbeat (T) = T₂; P = Pₙ₂ (column T₂);
go to Sort;
if tⱼ mod (10) = 0, then heartbeat (T) = T₁; P = Pₙ₁ (column T₁);
go to Sort;

Sort

Q = P to save P; sort P descending;

State

for (n = 1 to n = 15) if Pₙ > P_{L} then Sₙₘ =1 and mirror ontent n,
else Sₙₘ =0;
If j < J then j = j+ 1; go to Time else exit

END

In the MIRROR2 program, the Sort step enables the content to be mirrored in descending order of the respective probability values. The P vector is saved in a Q vector before being sorted, because probabilities within the P vector are correlated to a sequential ordering of the content and the sorting redistributes the probabilities within the P vector. Thus, the Q vector may be used to correlate the probabilities within the sorted P vector to the sequential ordering of the content.

The present invention is next generalized beyond the DRM example discussed supra.

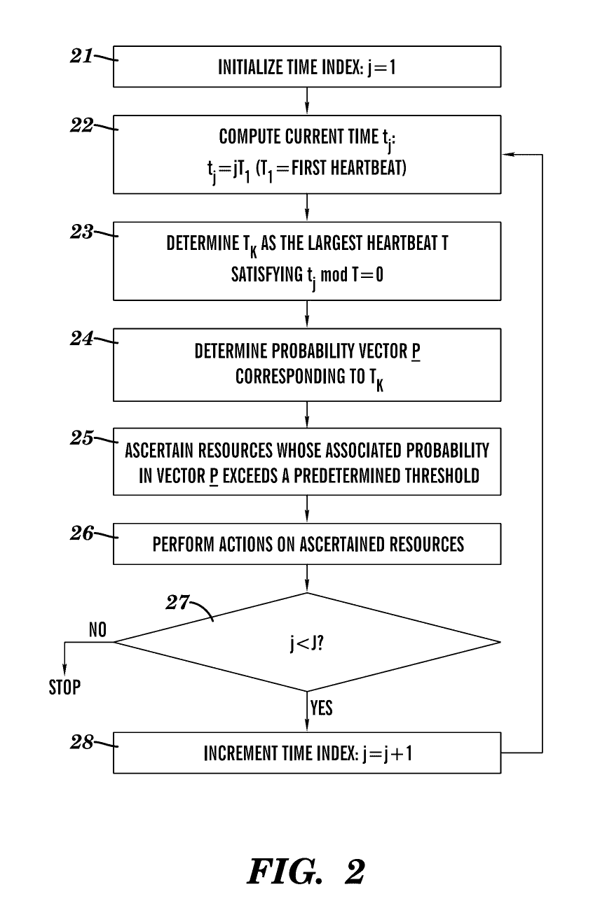

FIG. 2 is a flow chart of a method of dynamic resource selection for performing an action A on the selected resources, in accordance with embodiments of the present invention.

An example of resources is data content and an action on the data content is mirroring of the data content, as in the DRM example discussed supra. Generally, the resources may be, inter alia, hardware (action may be repairs, maintenance, disposal, etc.), software (action may be create new versions, virus checks, program development), data (action may be mirroring, encryption, caching), employees (actions may be hiring, firing, relocating, educating), oil (action may be drilling, storing, selling), etc.

The method of FIG. 2 makes use of [R], [T], [P], P_{L}, and J, which are defined as follows.

[R] denotes an ordered sequence of N resources denoted as R₁, R₂, . . . , R_{N} such that N is an integer of at least 3.

[T] denotes an ordered sequence of M heartbeats denoted as T₁, T₂, . . . , T_{M}, such that 0<T₁<T₂< . . . <T_{M}, each heartbeat Tₘ (m=1, 2, . . . , M) being an integral multiple of T₁, and M is an integer of at least 2.

[P] denotes, for each heartbeat Tm (m=1, 2, . . . , M), a probability of occurrence Pnm of the specified action A on resource Rₙ within a period of time equal to the heartbeat Tₘ, wherein P₁ₘ, P₂ₘ, . . . , P_{Nm} is an ordered sequence of N probabilities corresponding to Tₘ and respectively corresponding to the ordered sequence of N resources R₁, R₂, . . . , R_{N}. In one embodiment, the probabilities [P] are determined by analyzing historical data of performing the action A on the resources [R] in accordance with the heartbeats [T].

J is a positive integer of at least T_{M}/T₁.

P_{L} denotes a predetermined lower-limit threshold probability value. In one embodiment, P_{L} is heartbeat independent and constant. In one embodiment, P_{L} is heartbeat dependent and has a different value at more than one heartbeat of the M heartbeats. For instance in the DRM example, P_{L} may be 0.45, 0.50, 0.55, 0.65, or 0.75 if the current heartbeat is T₁, T₂, T₃, T₄, or T₅, respectively.

The method of FIG. 2 includes steps 21-28.

Step 21 initializes a time index j to 1 (i.e., j=1).

Step 22 computes a current time tⱼ via tⱼ=jT₁ wherein T₁ is the first heartbeat (i.e., m=1).

Step 23 determines a largest heartbeat T satisfying tⱼ mod T=0, which may be implemented by determining K as being a largest integer k from 1 to M satisfying tⱼ mod Tₖ=0, which determines a current heartbeat T=T_{K} as the largest heartbeat T satisfying tⱼ mod T=0.

Step 24 determines a probability vector P corresponding to the heartbeat T_{K}, wherein P is denoted as P_{1K}, P_{2K}, . . . , and P_{NK}.

Step 25 determines, a set {R} of resources from [R], wherein each resource R in the set {R} corresponds to a respective probability P in a set {P} selected from P_{1K}, P_{2K}, . . . , and P_{NK} such that each probability P in the set {P} satisfies P>P_{L}.

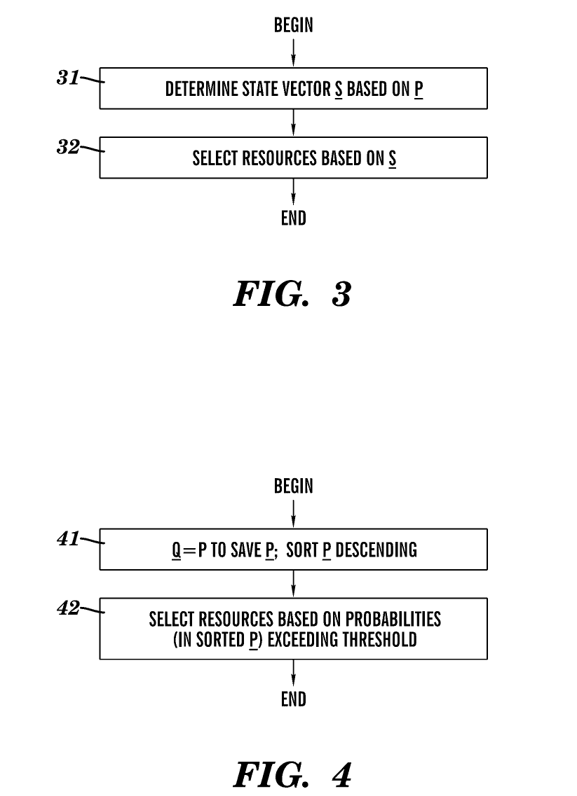

FIGS. 3 and 4 each depict a different process for implementing the determination, in step 25 of FIG. 2, of the resources on which the action A is to be performed, in accordance with embodiments of the present invention.

FIG. 3 includes steps 31 and 32. Step 31 determines a state vector S based on the probability vector P, such that the state vector S comprises elements Sₙ (n=1, 2, . . . , N) having a state value of 1 if the probability P_{nK} corresponding to resource n exceeds P_{L} and having a state value of 0 otherwise, wherein the set {P} in step 25 of FIG. 2 includes P_{nK} corresponding to resource n exceeding P_{L}. Step 32 selects each resource R for the set {R} as having the state of 1 in the state vector S.

FIG. 4 includes steps 41 and 42. Step 41 saves the vector P in a vector Q, after which the vector P is sorted descending to form a vector (P_{S}) of the sorted P. Step 42 performs the following functionalities: (i) maps, by using the vector Q, positions of the probabilities in P_{S} to corresponding positions of the probabilities in P; (ii) determines a lowest probability, in P_{S}, exceeding P_{L} to define a set of consecutive probabilities in P_{S}, from the first element of P_{S} to the element of P_{S} having the lowest probability exceeding P_{L}, wherein the set {P} in step 25 of FIG. 2 includes the set of consecutive probabilities in P_{S}.

Returning to FIG. 2, step 26 performs the action A on the ascertained resources (i.e., the action A is performed on each resource R in the set {R}). In one embodiment, in response to each performance of the action A on each resources in the set {R}, data that records the performed action A on each resource R in the set {R} is added to the historical data used to determine the probabilities [P].

Step 26 determines whether j is less than J. In so, step 28 increments j by 1 and loops back to step 22 to compute the next current time. If not (i.e., if j=J), the method ends.

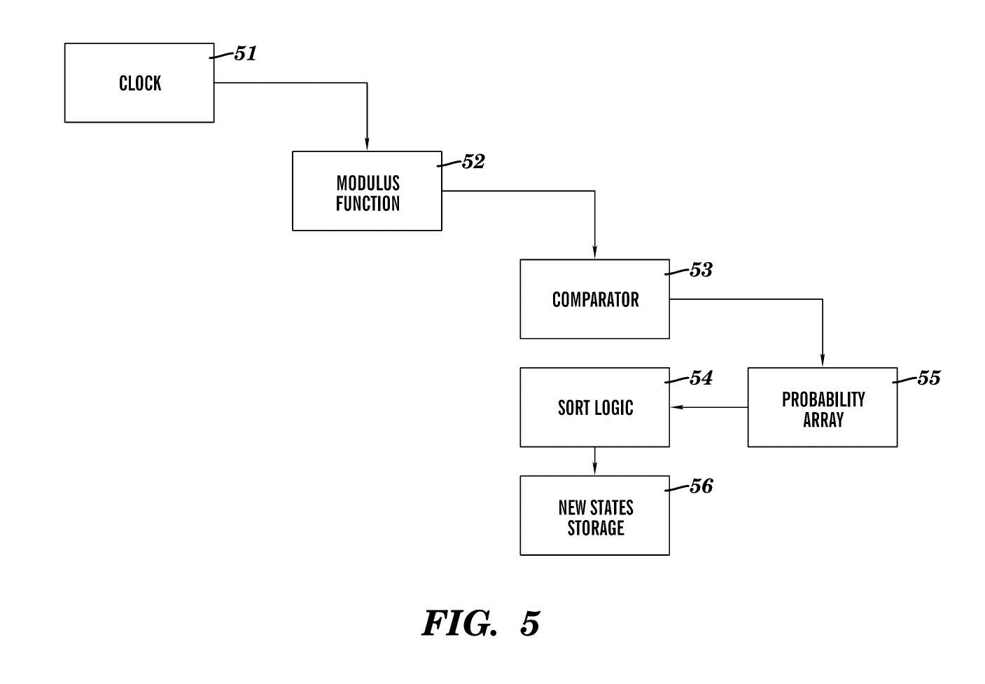

FIG. 5 depicts an application-specific integrated circuit (ASIC), in accordance with embodiments of the present invention. The ASIC in FIG. 5 comprises a clock 51, a modulus function 52, a comparator 53, a sort logic 54, a probability array 5, and new states storage 56. The clock 51 generates time in seconds (tⱼ=jT₁ for j=1, 2, . . . , J). The modulus function 52 uses the time input from clock 51 to generate an output of a current heartbeat T selected, based on the modulus function 52, as one of the heartbeats Tₘ (m=1, 2, . . . , M) in seconds (i.e., 10, 60, 300, 1800, 3600 for M=5 in the DRM example). The modulus function 52 implements determining K as being a largest integer k from 1 to M satisfying tⱼ mod Tₖ=0, which determines the current heartbeat T=T_{K}. The comparator 53 selects probabilities from the probability array 55 (Pₙₘ) to load into the sort logic 54. The sort logic 54 sorts the vector P and loads the new states (state vector S) into the new states storage 56.

Although the sort logic 54 has been described as implementing the method of FIG. 2 according to the embodiment of FIG. 4 (which includes sorting the vector P), the ASIC of FIG. 5 may be also used to implement the method of FIG. 2 according to the embodiment of FIG. 3.

While this invention uses an example for data base mirroring, this state machine concept of the preset invention is applicable to other problems in IT services including system provisioning in a data center or cloud, house keeping/patch management in a data center or cloud. Such a state machine capable of reducing cost of managing the environment by acceleration of prioritizing tasks based on such a history/learning process. The priority can also be varied by changing the sorting sequence depending on the evaluation of the probability of an event and execution time via techniques known in the art such as short circuit evaluation or lazy evaluation.

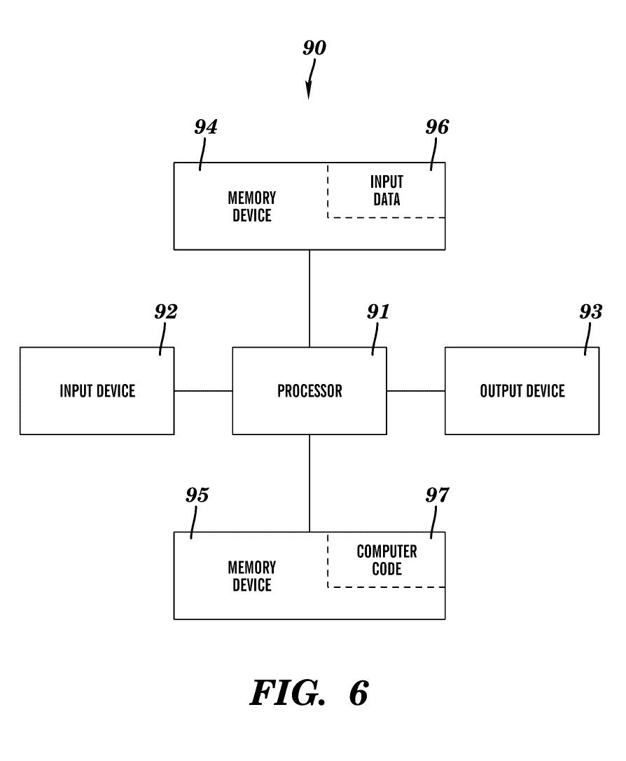

FIG. 6 illustrates a computer system 90 used for dynamic resource selection for performing an action on the selected resources, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97 which is a computer program that comprises computer-executable instructions. The computer code 97 includes software or program instructions that may implement an algorithm for dynamic resource selection for performing an action on the selected resources. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 8) may be used as a computer usable storage medium (or program storage device) having a computer readable program embodied therein and/or having other data stored therein, wherein the computer readable program comprises the computer code 97. Generally, a computer program product (or, alternatively, an article of manufacture) of the computer system 90 may comprise said computer usable storage medium (or said program storage device).

Thus the present invention discloses a process for supporting, deploying and/or integrating computer infrastructure, integrating, hosting, maintaining, and deploying computer-readable code into the computer system 90, wherein the code in combination with the computer system 90 is capable of performing a method for dynamic resource selection for performing an action on the selected resources.

In another embodiment, the invention provides a method that performs the process steps of the invention on a subscription, advertising, and/or fee basis. In this case, the service provider can create, integrate, host, maintain, deploy, manage, service, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

While FIG. 6 shows the computer system 90 as a particular configuration of hardware and software, any configuration of hardware and software, as would be known to a person of ordinary skill in the art, may be utilized for the purposes stated supra in conjunction with the particular computer system 90 of FIG. 6. For example, the memory devices 94 and 95 may be portions of a single memory device rather than separate memory devices.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of dynamic resource selection for performing an action A on the selected resources,
wherein the resource selection is in consideration [R], [T], [P] and P_{L},
wherein [R] denotes an ordered sequence of N resources denoted as R₁, R₂, . . . , R_{N} such that N is an integer of at least 3,
wherein [T] denotes an ordered sequence of M heartbeats denoted as T₁, T₂, . . . , T_{M}, such that 0<T₁<T₂< . . . <T_{M}, each heartbeat Tₘ (m=1, 2, . . . , M) being an integral multiple of T₁, and M is an integer of at least 2,
wherein [P] denotes, for each heartbeat Tₘ (m=1, 2, . . . , M), a probability of occurrence Pₙₘ of the action A on resource Rₙ within a period of time equal to the heartbeat Tₘ, wherein P₁ₘ, P₂ₘ, . . . , P_{Nm} is an ordered sequence of N probabilities corresponding to Tₘ and respectively corresponding to the ordered sequence of N resources R₁, R₂, . . . , R_{N},
wherein P_{L} denotes a specified lower-limit threshold probability value,
said method comprising: at each time tⱼ equal to jT₁ for j=1, 2, . . . , J such that J is a positive integer of at least T_{M}/T₁:
determining, by a hardware processor, K as being a largest integer k from 1 to M satisfying tⱼ mod Tₖ=0, which determines a current heartbeat T=T_{K};
determining, by the processor, a probability vector P corresponding to heartbeat T_{K}, wherein P is denoted as P_{1K}, P_{2K}, . . . , and P_{NK}; and
determining, by the processor, a set {R} of resources from [R], wherein each resource R in the set {R} corresponds to a respective probability P in a set {P} selected from P_{1K}, P_{2K}, . . . , and P_{NK} such that each probability P in the set {P} satisfies P>P_{L}, wherein the action A is configured to be performed on each resource R in the set {R}.

2. The method of claim 1, wherein said ascertaining comprises:
determining a state vector S comprising elements Sₙ (n=1, 2, . . . , N) having a state value of 1 if the probability P_{nK} corresponding to resource n exceeds P_{L} and having a state value of 0 otherwise, wherein the set {P} includes P_{nK} corresponding to resource n exceeding P_{L}; and
selecting each resource R for the set {R} as having the state of 1 in the state vector S.

3. The method of claim 1, wherein said ascertaining comprises:
saving the vector P in a vector Q;
after said saving the vector P, sorting the vector P descending to form a vector (P_{S}) of sorted P;
mapping, by using the vector Q, positions of the probabilities in P_{S} to corresponding positions of the probabilities in P;
determining a lowest probability, in P_{S}, exceeding P_{L} to define a set of consecutive probabilities in P_{S}, from the first element of P_{S} to the element of P_{S} having the lowest probability, wherein the set {P} includes the set of consecutive probabilities in P_{S};
selecting the resources R for the set {R} as corresponding to the set of consecutive probabilities in P_{S}.

4. The method of claim 1, wherein P_{L} is heartbeat independent and constant.

5. The method of claim 1, wherein P_{L} is heartbeat dependent and has a different value at more than one heartbeat of the M heartbeats.

6. The method of claim 1, further comprising,
at each time tⱼ after said determining the set {R}, said processor performing the action A on each resource R in the set {R}.

7. The method of claim 1, wherein the processor is a computer processor.

8. The method of claim 1, wherein the processor comprises an application specific integrated circuit (ASIC) particularized for performing the method.

9. The method of claim 1, further comprising,
determining, by the processor, the probabilities [P] by analyzing historical data of performing the action A on the resources [R] in accordance with the heartbeats [T].

10. The method of claim 9, said method further comprising:
in response to each performance of the action A on each resources in the set {R}, adding to the historical data, by the processor, data that records the performed action A on each resource R in the set {R}.

11. A computer program product, comprising a computer readable storage device storing computer readable program code which, upon being executed by a hardware processor, implements a method for dynamic resource selection for performing an action A on the selected resources,
wherein the resource selection is in consideration [R], [T], [P] and P_{L},
wherein [R] denotes an ordered sequence of N resources denoted as R₁, R₂, . . . , R_{N} such that N is an integer of at least 3,
wherein [T] denotes an ordered sequence of M heartbeats denoted as T₁, T₂, . . . , T_{M}, such that 0<T₁<T₂< . . . <T_{M}, each heartbeat Tₘ (m=1, 2, . . . , M) being an integral multiple of T₁, and M is an integer of at least 2,
wherein [P] denotes, for each heartbeat Tₘ (m=1, 2, . . . , M), a probability of occurrence Pₙₘ of the action A on resource Rₙ within a period of time equal to the heartbeat Tₘ, wherein P₁ₘ, P₂ₘ, . . . , P_{Nm} is an ordered sequence of N probabilities corresponding to Tₘ and respectively corresponding to the ordered sequence of N resources R₁, R₂, . . . , R_{N},
wherein P_{L} denotes a specified lower-limit threshold probability value,
said method comprising: at each time tⱼ equal to jT₁ for j=1, 2, . . . , J such that J is a positive integer of at least T_{M}/T₁:
determining, by a hardware processor, K as being a largest integer k from 1 to M satisfying tⱼ mod Tₖ=0, which determines a current heartbeat T=T_{K};
determining, by the processor, a probability vector P corresponding to heartbeat T_{K}, wherein P is denoted as P_{1K}, P_{2K}, . . . , and P_{NK}; and
determining, by the processor, a set {R} of resources from [R], wherein each resource R in the set {R} corresponds to a respective probability P in a set {P} selected from P_{1K}, P_{2K}, . . . , and P_{NK} such that each probability P in the set {P} satisfies P>P_{L}, wherein the action A is configured to be performed on each resource R in the set {R}.

12. The computer program product of claim 11, wherein said ascertaining comprises:
determining a state vector S comprising elements Sₙ (n=1, 2, . . . , N) having a state value of 1 if the probability P_{nK} corresponding to resource n exceeds P_{L} and having a state value of 0 otherwise, wherein the set {P} includes P_{nK} corresponding to resource n exceeding P_{L}; and
selecting each resource R for the set {R} as having the state of 1 in the state vector S.

13. The computer program product of claim 11, wherein said ascertaining comprises:
saving the vector P in a vector Q;
after said saving the vector P, sorting the vector P descending to form a vector (P_{S}) of sorted P;
mapping, by using the vector Q, positions of the probabilities in P_{S} to corresponding positions of the probabilities in P;
determining a lowest probability, in P_{S}, exceeding P_{L} to define a set of consecutive probabilities in P_{S}, from the first element of P_{S} to the element of P_{S} having the lowest probability, wherein the set {P} includes the set of consecutive probabilities in P_{S};
selecting the resources R for the set {R} as corresponding to the set of consecutive probabilities in P_{S}.

14. The computer program product of claim 11, wherein P_{L} is heartbeat independent and constant.

15. The computer program product of claim 11, wherein P_{L} is heartbeat dependent and has a different value at more than one heartbeat of the M heartbeats.

16. A system, comprising a processor, a memory coupled to the processor, and a computer readable storage device coupled to the processor, said storage device containing program code which, upon being executed by the processor via the memory, implements a method for dynamic resource selection for performing an action A on the selected resources,
wherein the resource selection is in consideration [R], [T], [P] and P_{L},
wherein [R] denotes an ordered sequence of N resources denoted as R₁, R₂, . . . , R_{N} such that N is an integer of at least 3,
wherein [T] denotes an ordered sequence of M heartbeats denoted as T₁, T₂, . . . , T_{M}, such that 0<T₁<T₂< . . . <T_{M}, each heartbeat Tₘ (m=1, 2, . . . , M) being an integral multiple of T₁, and M is an integer of at least 2,
wherein [P] denotes, for each heartbeat Tₘ (m=1, 2, . . . , M), a probability of occurrence Pₙₘ of the action A on resource Rₙ within a period of time equal to the heartbeat Tₘ, wherein P₁ₘ, P₂ₘ, . . . , P_{Nm} is an ordered sequence of N probabilities corresponding to Tₘ and respectively corresponding to the ordered sequence of N resources R₁, R₂, . . . , R_{N},
wherein P_{L} denotes a specified lower-limit threshold probability value,
said method comprising: at each time tⱼ equal to jT₁ for j=1, 2, . . . , J such that J is a positive integer of at least T_{M}/T₁:
determining, by a hardware processor, K as being a largest integer k from 1 to M satisfying tⱼ mod Tₖ=0, which determines a current heartbeat T=T_{K};
determining, by the processor, a probability vector P corresponding to heartbeat T_{K}, wherein P is denoted as P_{1K}, P_{2K}, . . . , and P_{NK}; and
determining, by the processor, a set {R} of resources from [R], wherein each resource R in the set {R} corresponds to a respective probability P in a set {P} selected from P_{1K}, P_{2K}, . . . , and P_{NK} such that each probability P in the set {P} satisfies P>P_{L}, wherein the action A is configured to be performed on each resource R in the set {R}.

17. The system of claim 16, wherein said ascertaining comprises:
determining a state vector S comprising elements Sₙ (n=1, 2, . . . , N) having a state value of 1 if the probability P_{nK} corresponding to resource n exceeds P_{L} and having a state value of 0 otherwise, wherein the set {P} includes P_{nK} corresponding to resource n exceeding P_{L}; and
selecting each resource R for the set {R} as having the state of 1 in the state vector S.

18. The system of claim 16, wherein said ascertaining comprises:
saving the vector P in a vector Q;
after said saving the vector P, sorting the vector P descending to form a vector (P_{S}) of sorted P;
mapping, by using the vector Q, positions of the probabilities in P_{S} to corresponding positions of the probabilities in P;
determining a lowest probability, in P_{S}, exceeding P_{L} to define a set of consecutive probabilities in P_{S}, from the first element of P_{S} to the element of P_{S} having the lowest probability, wherein the set {P} includes the set of consecutive probabilities in P_{S};
selecting the resources R for the set {R} as corresponding to the set of consecutive probabilities in P_{S}.

19. The system of claim 16, wherein P_{L} is heartbeat independent and constant.

20. The system of claim 16, wherein P_{L} is heartbeat dependent and has a different value at more than one heartbeat of the M heartbeats.
